(19) United States
(12) Patent Application Publication
(10) Pub. No.: US 2010/0172166 A1
(43) Pub. Date: Jul. 8, 2010

(54) PLUG-IN NEUTRAL REGULATOR FOR 3-PHASE 4-WIRE INVERTER/CONVERTER SYSTEM

(76) Inventors: Tejinder Singh, Burlington (CA); Hong Zhang, Mississauga (CA); Hassan Ali Kojori, Mississauga (CA)

Correspondence Address: HONEYWELL/SHIMOKAJI;PATENT SERVICES, 101 Columbia Road, P.O.Box 2245, Morristown, NJ, 07962-2245, US

(21) Appl. No.: 12/350,148

(22) Filed: Jan. 7, 2009

(51) Int. Cl. H02M 7/537; G05F 3/02

(52) U.S. Cl. 363/131; 307/149

(57) ABSTRACT

A neutral line regulator is designed as a plug-in module or new integrated inverter with a lower rating 4th-leg, instead of using a conventional four-leg inverter to supply power to three-phase four-wire unbalanced AC loads or three-phase nonlinear loads without a neutral connection. The neutral line regulator may be designed for controlling only the unbalanced power rather than using a fully rated inverter leg. Since this plug-in module may be separate from the main inverter and may operate at a lower power, the switching frequency may be higher than the main inverter. Thus, the size and weight requirements for providing the neutral line can be significantly reduced. In addition, the plug-in regulator may maintain voltage balance between the center-tapped DC link capacitors for non-linear, unbalanced loads. Moreover, the plug-in module may be used as a retrofit module replacing, for example, delta-wye transformers.

### BACKGROUND OF THE INVENTION

The present invention relates to a plug-in neutral regulator and, more particularly, a plug-in neutral regulator for a three-phase 4-wire system to control only unbalanced power rather than using a fully rated inverter leg.

A pulse-width modulator (PWM) inverter is widely used to produce three-phase power from a direct current (DC) source to feed alternating current (AC) motors or AC loads. This inverter is a three-phase three-wire AC source to the load. For applications where both single phase and three phase loads are connected to the output of the inverter, a three-phase four-wire system is required, and a delta-wye transformer, an auto-transformer or zig-zag transformer is typically used to create the fourth line (i.e., neutral), as shown in FIG. 1. The DC current 100 may be converted to three-phase three-wire AC current through an inverter 102. The delta-wye transformer 104 may be used to create a neutral line 104 to provide three-phase four-wire AC current to various loads 106.

Referring FIG. 2, a prior-art transformer-less approach may be taken which may use a four-leg inverter 200 which may convert DC current 202 into three-phase four-wire AC current to feed various loads 204. The fourth leg 206 in the inverter is designed to the same power rating as the other legs in the three-phase inverter to maintain the power balance between the fourth line (neutral) and the others. In this system, control of the fourth leg 206 is fairly complex, and has to be integrated simultaneously into the controls of three-phase inverter 200, and thus the fourth leg can not be easily implemented in addition to an existing retrofit three phase voltage source inverter due to complexity of controls and the need for coordination with the other controlled devices of the existing inverter without undue time-delays between gating patterns which have to be communicated to an external unit.

As can be seen, there is a need for an inverter/converter system that can produce a three-phase four-wire output without the need for a bulky four-leg inverter and without the need for separate module, such as a delta-wye transformer.

### SUMMARY OF THE INVENTION

In one aspect of the present invention, a plug-in neutral module comprises a first input from a positive direct current (DC) bus; a second input from a negative DC bus; and a neutral line output from the plug-in neutral module.

In another aspect of the present invention, an inverter system comprises an inverter for converting a positive direct current (DC) voltage and a negative DC voltage to a three-phase three-wire alternating current (AC) voltage; and a neutral module connected to a positive DC bus and a negative DC bus, the neutral module providing a neutral line, thereby providing a three-phase four-wire AC current voltage to various loads.

In a further aspect of the present invention, a three-phase four-wire alternating current (AC) power supply system comprises a positive direct current (DC) bus; a negative DC bus; an inverter receiving a DC signal from the positive and negative DC busses, the inverter outputting three-phase three-wire AC power; a DC neutral point created by a mid-point of two split capacitors connected between the positive DC bus and the negative DC bus (split-capacitor for the DC bus of plug-in module is necessary, but optional for the three-phase inverter); and a separate, plug-in neutral module connected to the positive DC bus, the negative DC bus and the DC neutral point, wherein the neutral module maintains a voltage balance across each of the two split capacitors for an unbalanced load, and wherein the neutral module provides a neutral line to give a three-phase four-wire AC power supply.

These and other features, aspects and advantages of the present invention will become better understood with reference to the following drawings, description and claims.

### BRIEF DESCRIPTION OF THE DRAWINGS

FIG. 1 is a block diagram showing a neutral line formed using transformers, according to the prior art;

FIG. 2 is a block diagram showing a neutral line formed using a three-phase four-wire inverter, according to the prior art;

FIG. 3 is a block diagram showing a neutral line formed using a plug-in neutral regulator module, according to an embodiment of the present invention;

FIG. 4 is a schematic diagram showing neutral point creation using two capacitors, according to a comparative example;

FIG. 5A is a graph showing output phase-neutral voltages caused by an unbalanced/non-linear load, as applied to the schematic of FIG. 4;

FIG. 5B is a graph showing unbalanced voltages across capacitors caused by an unbalanced/non-linear load, as applied to the schematic of FIG. 4;

FIG. 6 is a schematic diagram showing the neutral line regulator, according to an embodiment of the present invention;

FIG. 7 is a graph showing concept of controlling the split capacitor voltages in real-time to be of equal magnitude during the use of the neutral line regulator of FIG. 6;

FIG. 8 is a schematic diagram showing a control module for a neutral regular, according to an embodiment of the present invention; and

FIG. 9 shows graphs of simulation results of using the neutral regulator of an embodiment of the present invention with non-balanced non-linear loads.

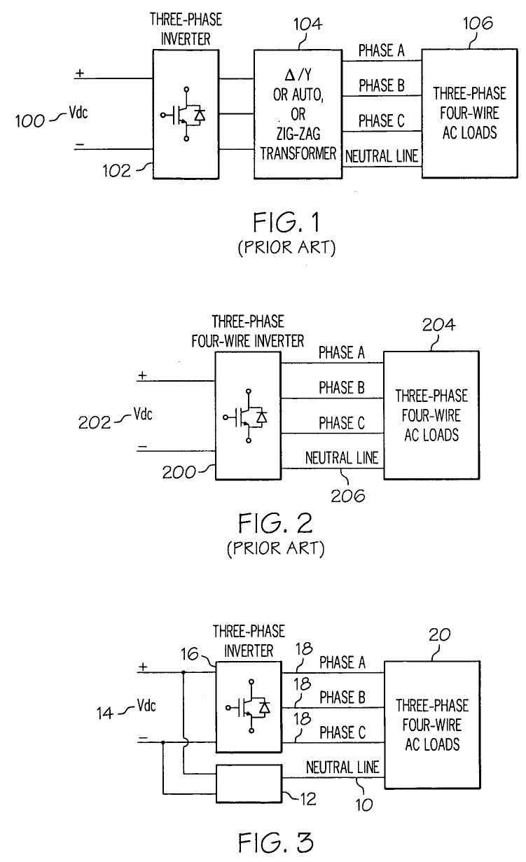

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features. However, any single inventive feature may not address any of the problems discussed above or may only address one of the problems discussed above. Further, one or more of the problems discussed above may not be fully addressed by any of the features described below.

Broadly, the present invention provides a neutral line regulator as a plug-in module that can be easily used as an upgrade to an existing retrofit system, providing capability to supply power to unbalanced/nonlinear loads. The neutral line regulator according to embodiments of the present invention may be designed for controlling only the unbalanced power rather than using a fully rated inverter leg. Since this plug-in module may be separate from the main inverter and may operate at a lower power, the switching frequency could be higher than the main inverter. Thus, the size and weight can be significantly reduced. In addition, the plug-in regulator of an embodiment of the present invention may maintain voltage balance between the center-tapped DC link capacitors for non-linear, unbalanced loads, as described in greater detail below. Moreover, the plug-in module according to embodiments of the present invention may be used as a retrofit module, replacing, for example, delta-wye transformers to reduce overall weight and volume. Because the neutral line regulator is a separate plug-in module, no coordination is needed between the plug-in module and the existing inverter and/or transformer. For a well-balanced load, the neutral line will not carry any fundamental current. The fourth leg is not required in this case. The neutral line is required only to regulate power for the unbalanced loads. Embodiments of the present invention may also be used to provide an effective solution to eliminate unbalanced DC capacitor voltages at the mid-point of the DC bus due to manufacturing tolerances, inconsistency in switching device characteristics or non-linear/unbalanced three-phase loads which are supplied with a three-wire AC system.

Referring to FIG. 3, there is shown a block diagram of a neutral line 10 formed using a plug-in neutral regulator module 12, according to an embodiment of the present invention. The neutral line regulator module 12 may receive DC current 14 prior to the DC current 14 being passed through a three-phase inverter 16. The three-phase inverter 16 may provide three-phase three-wire AC output 18. The neutral line regulator module 12 may provide the neutral line 10. Thus, between the inverter 16 and the neutral line regulator module 12, a three-phase four-wire output may be provided to various loads 20.

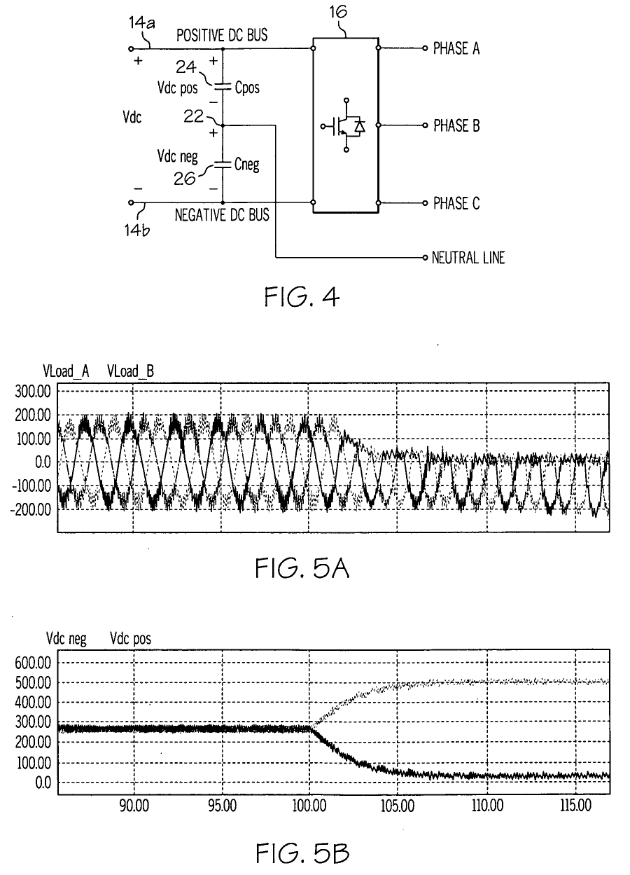

Referring now to FIG. 4, there is shown a schematic diagram of a neutral point 22 creation using two capacitors 24, 26. The neutral point 22 may be created by a mid-point of two split capacitors 24, 26. When the inverter loads 20 are balanced, the power drawn between the positive DC bus 14a and the negative DC bus 14b should be equal and the voltage across two capacitors 24, 26 should be equally divided.

For an unbalanced and/or a non-linear inverter load condition, the power delivered through the positive DC bus 14a and neutral-line 22 would not be the same as the power delivered through negative DC bus 14b and neutral-line 22 resulting in unbalanced capacitor voltages. Voltage across one capacitor 24 may drift toward the full DC bus voltage while the voltage across the other capacitor 26 may drop close to zero. FIGS. 5A and 5B shows one such situation where an unbalanced load condition is introduced to the three-phase inverter of FIG. 4 after symmetrical load operation for about 100 ms. As soon as the unsymmetrical load is introduced, the output phase-neutral voltages of the inverter become distorted, as illustrated in FIGS. 5A and 5B and further explained in the following section.

At the 100 millisecond (ms) time point in FIGS. 5A and 5B, an unbalanced load is drawn from the inverter 16. FIG. 5A shows the output phase-neutral voltages for each of phase A, phase B and phase C (see FIG. 4) changing from a normal three-phase voltage waveform to a distorted AC voltage waveform. FIG. 5B shows the voltages across the capacitors 24, 26, wherein the voltage across one capacitor approaches the full DC bus voltage while the voltage across the other capacitor approaches zero.

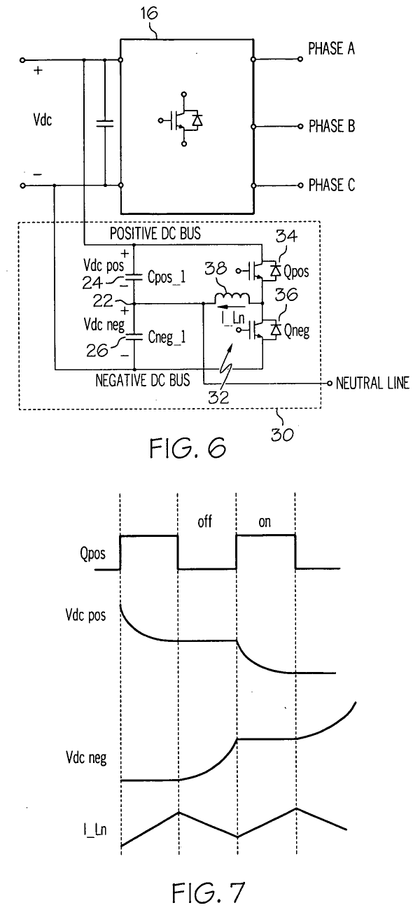

Referring to FIG. 6, there is shown a schematic diagram of a neutral line regulator 30, according to an embodiment of the present invention. To maintain the voltage across the two capacitors, 24, 26 as shown in FIG. 4, capacitors with very large capacitance may be required (even then, equal voltages for split-caps may not be obtained due to the severity of voltage unbalance). This may significantly increase the weight, volume and cost and may not be practical. This problem may be overcome by the introduction of a high-frequency switched power electronic circuit 32 to regulate two capacitor voltages to be equal under unbalanced load conditions. In FIG. 6, two insulated gate bipolar transistors (IGBTs) with anti parallel diodes or switching device of similar configuration with bidirectional control of power 34, 36 and one inductor 38 may be used to satisfy this goal.

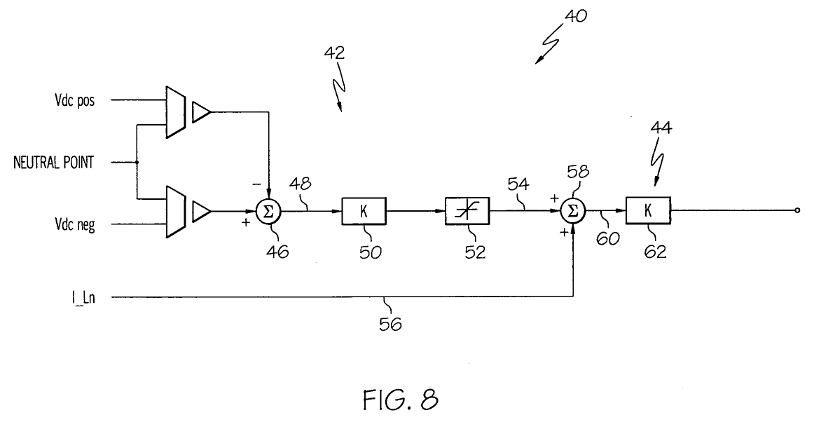

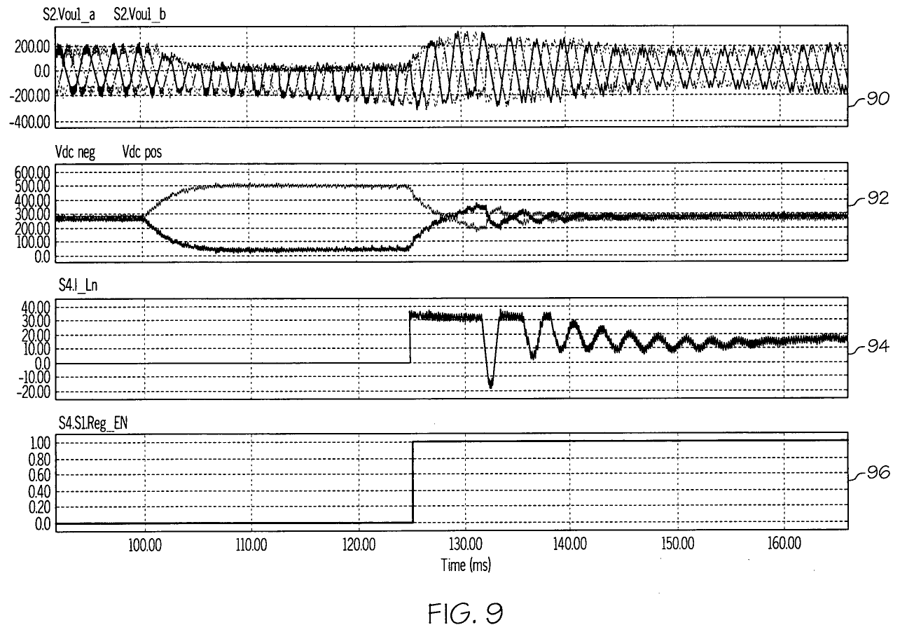

Referring to FIGS. 6 and 7, in one example of the present invention, assume the capacitor voltage across the capacitor 24 (Vdc_pos) is higher than the voltage across the capacitor 26 (Vdc_neg) due to an unbalanced load. The IGBT with anti parallel diode or switching device of similar configuration with bidirectional control of power 34 may be switched on and off to force Vdc pos to decrease and Vdc_neg to increase, as shown in FIG. 7. The end result of enabling the neutral line regulator 30 is further described in the discussion of FIG. 9, below.

For the purpose of illustration, referring now to FIG. 8, there is shown a schematic diagram of a computer simulation control module 40 for the neutral regular 30, according to an embodiment of the present invention. The control module 40 may include two control loops—a voltage outer loop 42 and a current inner loop 44.

The voltage outer loop 42 may compare the voltages of the two capacitors 24, 26 (see FIG. 6) at summing block 46. An error signal 48 may be processed at controller block 50 before being fed to a limiter 52. The controller 50 may be, for example, a proportional (P) controller or a proportional integral (PI) controller. The limiter output 54 may be summed with an inductor current signal 56 at summing block 58 to provide a current command 60 for the current inner loop 44.

The current inner loop 44 may help ensure fast, dynamic and response and protection. Current inner loop 44 may generate the gating pattern for the switching devices ‘IGBTs’ (or switching device of similar configuration with bidirectional control of power) 34 and 36 of the plug in neutral regulator 30. This control may incorporate an inner current loop 44 to regulate the neutral terminal for the unbalanced load at desired power which is different from control described in prior art.

FIG. 9 shows graphs of simulation results of using the neutral regulator of an embodiment of the present invention with non-balanced non-linear loads. At about the 100 ms time point, an unbalanced non-linear load may be applied. This creates the phase-neutral voltage distortions at the output of inverter as shown in the top graph 90 as well as the capacitor voltages as shown in the second graph 92. Up until the 125 ms time point, these graphs 90, 92 are similar to that described above with respect to FIG. 5.

At about the 125 ms time point, the neutral regulator 30 may be enabled, as shown in the bottom graph 96. The switching IGBTs or switching device of similar configuration with bidirectional control of power 34, 36 may create an inductor current signal 56 as shown in the third graph 94. Within less than 5 ms, the capacitor voltages are close to the midpoint voltage as shown in graph 92. Moreover, the distortion in the output phase neutral voltages, as shown in graph 90, is dissipated.

Those skilled in the art would appreciate that the concepts described for the standalone plug-in module of an embodiment of the present invention are completely different from those described in the prior art. The scope of the present invention can be expanded to cover many other applications where a split DC link capacitor with similar configuration is required. For example, the concepts presented in the present invention could also be advantageously used not in a limiting sense for achieving:
a) an integrated 4-leg inverter where as opposed to prior art, wherein the controls are much simpler, dynamic performance is much faster and the rating of the 4^{th}-leg devices is reduced resulting in smaller weight and size due to reduction in physical foot-print and lower thermal management requirements. Furthermore, only a small portion of the DC link capacitor needs to be split which may result in reduced cost and overall reliability; and
b) balancing the voltages of a three-level voltage source inverter which has a similar configuration of center tapped DC Link capacitor.

It should be understood, of course, that the foregoing relates to exemplary embodiments of the invention and that modifications may be made without departing from the spirit and scope of the invention as set forth in the following claims.

We claim:

1. A plug-in neutral module comprising:
a first input from a positive direct current (DC) bus;
a second input from a negative DC bus; and
a neutral line output from the plug-in neutral module.

2. The plug-in neutral module of claim 1, wherein the neutral line output connects to a neutral point created by a mid-point of two split capacitors connected between the positive DC bus and the negative DC bus.

3. The plug-in neutral module of claim 1, wherein, when a positive voltage at the positive DC bus is not equal in magnitude to a negative voltage at the negative DC bus, a switching device in the neutral module switches on and off to balance the positive DC bus and the negative DC bus.

4. The plug-in neutral module of claim 3, further comprising a first insulated gate bipolar transistor (IGBT) with anti parallel diode, or a switching device of similar configuration with bidirectional control of power, as the switching device.

5. The plug-in neutral module of claim 3, further comprising:
a first insulated gate bipolar transistor (IGBT) with anti parallel diode, or switching device of similar configuration with bidirectional control of power, connecting the positive DC bus with an inductor; and
a second IGBT with anti parallel diode, or switching device of similar configuration with bidirectional control of power, connecting the negative DC bus with the inductor.

6. The plug-in neutral module of claim 5, wherein an output from the inductor is the neutral line.

7. The plug-in neutral module of claim 6, wherein the neutral line connects to a neutral point created by a mid-point of two split capacitors connected between the positive DC bus and the negative DC bus.

8. The plug-in neutral module of claim 7, further comprising a control module, the control module receiving a) a voltage measured across at least one of the two split capacitors; and b) a current signal from the inductor, and the control module outputting a switching signal to the first and second IGBTs with anti parallel diodes, or switching device of similar configuration with bidirectional control of power.

9. The plug-in module of claim 1, wherein the neutral line output is only rated for an unbalanced portion of a three-phase load.

10. An inverter system comprising:
an inverter for converting a positive direct current (DC) voltage and a negative DC voltage to a three-phase three-wire alternating current (AC) voltage; and
a neutral module connected to a positive DC bus and a negative DC bus, the neutral module providing a neutral line, thereby providing a three-phase four-wire AC current and voltage to various loads.

11. The inverter system of claim 10, wherein the neutral module is a plug-in module, separate from the inverter.

12. The inverter system of claim 10, wherein the neutral module further comprises:
a first insulated gate bipolar transistor (IGBT) with anti parallel diode, or switching device of similar configuration with bidirectional control of power, connecting the positive DC bus with an inductor; and
a second IGBT with anti parallel diode, or switching device of similar configuration with bidirectional control of power, connecting the negative DC bus with the inductor,
wherein an output from the inductor is the neutral line.

13. The inverter system of claim 12, wherein the neutral line receives only an unbalanced portion of the various loads on the three-phase AC voltage.

14. The inverter system of claim 12, wherein, when a positive voltage at the positive DC bus is greater in magnitude to a negative voltage at the negative DC bus, the first IGBT with anti parallel diode, or switching device of similar configuration with bidirectional control of power, switches on and off to cause the voltage at the positive DC bus to decrease and the voltage at the negative DC bus to increase.

15. The inverter system of claim 12, wherein, when a positive voltage at the positive DC bus is less in magnitude than a negative voltage at the negative DC bus, the second IGBT with anti parallel diode, or switching device of similar configuration with bidirectional control of power, switches on and off to cause the voltage at the positive DC bus to increase and the voltage at the negative DC bus to decrease.

16. A three-phase four-wire alternating current (AC) power supply system comprising:
a positive direct current (DC) bus;
a negative DC bus;
an inverter receiving a DC signal from the positive and negative DC busses, the inverter outputting three-phase three-wire AC power;
a DC neutral point created by a mid-point of two split capacitors connected between the positive DC bus and the negative DC bus; and
a separate, plug-in neutral module connected to the positive DC bus, the negative DC bus and the DC neutral point, wherein
the neutral module maintains a voltage balance across each of the two split capacitors for an unbalanced load, and wherein the neutral module provides a neutral line to give a three-phase four-wire AC power supply.

17. The power supply system of claim 16, wherein the neutral module further comprises:
a first insulated gate bipolar transistor (IGBT) with anti parallel diode, or switching device of similar configuration with bidirectional control of power, connecting the positive DC bus with an inductor; and
a second IGBT with anti parallel diode, or switching device of similar configuration with bidirectional control of power, connecting the negative DC bus with the inductor,
wherein an output from the inductor connects to the DC neutral point.

18. The power supply system of claim 16, wherein the need for a separate transformer or autotransformer for the creation of the neutral line is eliminated.

19. The power supply system of claim 16, wherein the switching frequency of the neutral module can be different than the switching frequency of the inverter.
